(19) United States
(12) Patent Application Publication
(10) Pub. No.: US 2019/0045000 A1
(43) Pub. Date: Feb. 7, 2019

(54) TECHNOLOGIES FOR LOAD-AWARE TRAFFIC STEERING

(71) Applicant: Intel Corporation, Santa Clara, CA (US)

(72) Inventors: Chetan Hiremath, Portland, OR (US); Timothy Verrall, Pleasant Hill, CA (US); Andrey Chilikin, Limerick (IE); Thomas Long, Shannon (IE); Maryam Tahhan, Co Limerick (IE); Eoin Walsh, Shannon (IE); Andrew Duignan, Ennis (IE); Rory Browne, Limerick (IE)

(21) Appl. No.: 16/023,733

(22) Filed: Jun. 29, 2018

(51) Int. Cl. H04L 29/08; H04L 12/721

(52) U.S. Cl. CPC H04L 67/1031; H04L 67/1008; H04L 45/70

(57) ABSTRACT

Technologies for load-aware traffic steering include a compute device that includes a multi-homed network interface controller (NIC) with a plurality of NICs. The compute device determines a target virtual network function (VNF) of a plurality of VNFs to perform a processing operation on a network packet. The compute device further identifies a first steering point of a first NIC to steer the received network packet to virtual machines (VMs) associated with the target VNF and retrieves a resource utilization metric that corresponds to a usage level of a component of the compute device used by the VMs to process the network packet. Additionally, the compute device determines whether the resource utilization metric indicates a potential overload condition and provides a steering instruction to a second steering point of a second NIC that is usable to redirect the network traffic to the other VMs via the identified second steering point.

### BACKGROUND

Network operators and service providers typically rely on various network virtualization technologies to manage complex, large-scale computing environments, such as high-performance computing (HPC) and cloud computing environments. For example, network operators and service provider networks may rely on network function virtualization (NFV) deployments to deploy network services (e.g., firewall services, network address translation (NAT) services, deep packet inspection (DPI) services, evolved packet core (EPC) services, mobility management entity (MME) services, packet data network gateway (PGW) services, serving gateway (SGW) services, billing services, transmission control protocol (TCP) optimization services, etc.).

Such NFV deployments typically involve placing virtual network functions (VNFs) on commercial off-the-shelf servers with general purpose hardware (e.g., to replace legacy, custom-purposed hardware). The VNFs are typically placed into various virtual machines (VMs) or containers to perform virtualized network services on network traffic and to manage the network traffic across the various VMs. Unlike traditional, non-virtualized deployments, virtualized deployments decouple network functions from underlying hardware, which results in network functions and services that are highly dynamic. As such, the VNFs can be scaled-in/out as necessary based on particular functions or network services to be performed on the network traffic. Network traffic is generally steered or otherwise distributed into the VNFs based on a protocol or an application identifier associated with the network traffic. However, certain conditions may exist that result in a VNF being overloaded and, as a result, network traffic being dropped, which can affect a subscriber's experience, violate a service level agreement (SLA), etc.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a system for load-aware traffic steering that includes a network compute device communicatively coupled to multiple compute devices;

FIG. 2 is a simplified block diagram of at least one embodiment of the compute device of the system of FIG. 1 that includes a multi-homed network interface controller (NIC);

FIG. 3 is a simplified block diagram of at least one embodiment of the multi-homed NIC of the compute device of FIG. 2;

FIG. 4 is a simplified block diagram of at least one embodiment of an environment of the compute device of FIGS. 1 and 2;

FIG. 5 is a simplified block diagram of at least one other embodiment of an environment of the compute device of FIGS. 1 and 2;

FIG. 6 is a simplified flow diagram of at least one embodiment of a method for load-aware traffic steering that may be executed by the compute device of FIGS. 1-4;

FIG. 7 is a simplified block diagram of at least one embodiment of a communication flow for intra-socket load-aware traffic steering that may be executed by the compute device of FIGS. 1-3; and

FIG. 8 is a simplified block diagram of at least one embodiment of a communication flow for inter-socket load-aware traffic steering that may be executed by the compute device of FIGS. 1-3.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one of A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on one or more transitory or non-transitory machine-readable (e.g., computer-readable) storage media, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

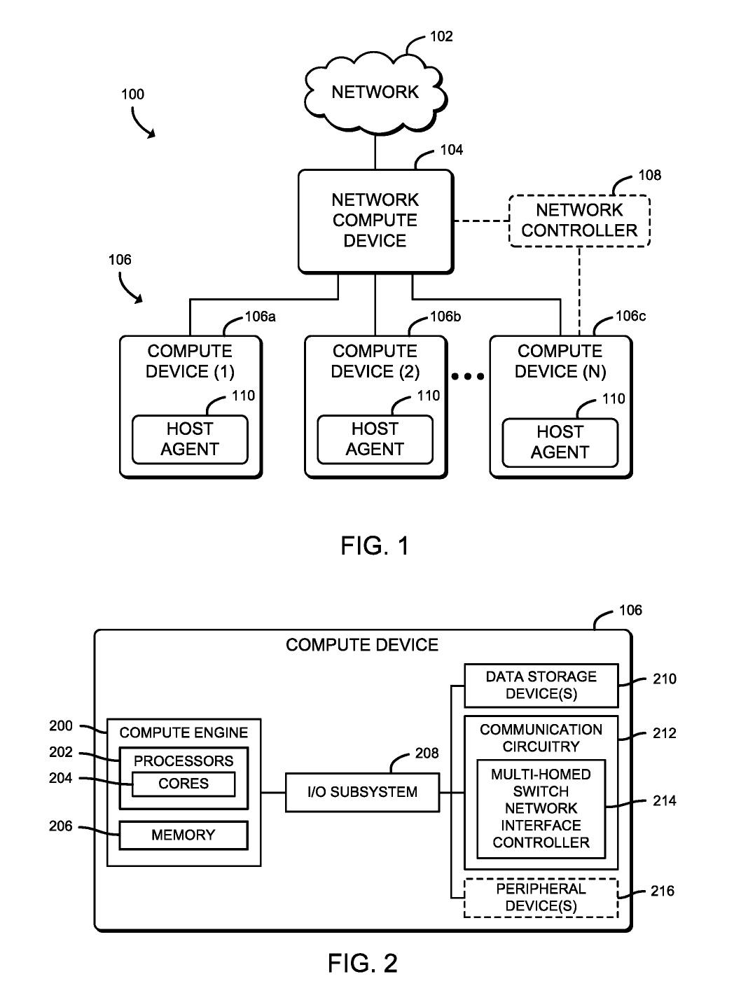

Referring now to FIG. 1, in an illustrative embodiment, a system 100 for load-aware traffic steering includes a network compute device 104 communicatively coupled to multiple compute devices 106 (e.g., in an edge/fog computing environment, in a cloud environment, in a data center, etc.). As shown in the illustrative system 100, the compute devices 106 include a first compute device 106 designated as compute device (1) 106a, a second compute device 106 designated as compute device (2) 106b, and a third compute device 106 designated as compute device (N) 106c (e.g., in which the compute device (N) 106b represents the “Nth” compute device 106 and “N” is a positive integer). It should be appreciated that while only a single network compute device 104 is illustratively shown, multiple network compute devices 104 may be employed in other embodiments.

In use, the compute devices 106 are configured to steer network traffic (i.e., network packets, frames, portions thereof, etc.) to applicable virtual machine(s) (VM(s)) or processing core(s) such that one or more processing operations can be performed on at least a portion of the received network traffic. However, under certain conditions, the VM(s)/processing core(s) associated with a VNF that the network traffic is being steered toward can become overloaded. For example, the original steering decision is not predicated upon the target resource usage. As such, certain conditions may be present where the target VNF is overloaded and would likely result in dropped packets if the network traffic were steered to the target VNF as originally intended, which can have an adverse effect on subscriber Quality of Experience (QoE) and Service Level Agreement (SLA). Accordingly, each of the compute devices 106, or more particularly a respective host agent 110 deployed thereon, which is described in further detail below, is configured to dynamically adjust the steering based on one or more conditions as described herein.

To do so, the compute device 106 is configured to identify a processing load of the VNF(s) that are to process the received network traffic. The processing load may be any metric usable to determine whether a resource associated with a VNF has become or is otherwise anticipated to become overloaded. For example, the processing load may include a compute load (e.g., compute usage of one or more processor cores associated with the VNF, compute usage by one or more VMs associated with the VMs, etc.), a memory load (e.g., thermal conditions of the memory), a power load, etc. Additionally, the compute device 106 is configured to determine whether the processing load indicates that the VNF have become overloaded or are otherwise anticipated to become overloaded (e.g., based on a maximum processing load threshold) based on the processing load of the respective VM(s) and/or processing core(s) associated therewith. Upon determining that the processing load indicates that one or more resources of the VNF has become overloaded or has exceeded a processing load threshold, the compute device 106 is configured to adjust the steering point of the affected network traffic to send the affected network traffic to other VM(s)/processing core(s). It should be appreciated that, depending on the conditions/resources allocated to the VNF, the network traffic may be directed to other VM(s)/processing core(s) of the same VNF or to other VM(s)/processing core(s) of a different VNF.

In some embodiments, the threshold monitoring by the host agent 110 may have built-in hysteresis into the steering logic, such that control plane flapping may be avoided. Accordingly, the steering redirection logic may be activated upon reaching or exceeding a maximum processing load threshold and deactivated when the processing load drops below a minimum processing load threshold. While the resource utilization metric is illustratively described herein as a processing load, it should be appreciated that, in other embodiments, additional and/or alternative resource utilization metrics may be used.

Each of the compute devices 106 may be embodied as any type of computation or computer device capable of performing the functions described herein, including, without limitation, a server (including, e.g., stand-alone server, rack-mounted server, blade server, etc.), a sled (e.g., a compute sled, an accelerator sled, a storage sled, a memory sled, etc.), an enhanced NIC (e.g., a host fabric interface (HFI)), a distributed computing system, or any other combination of compute/storage device(s) capable of performing the functions described herein. Referring now to FIG. 2, the illustrative compute device 106 includes a compute engine 200, an I/O subsystem 208, one or more data storage devices 210, communication circuitry 212, and, in some embodiments, one or more peripheral devices 216. It should be appreciated that the compute device 106 may include other or additional components, such as those commonly found in a typical computing device (e.g., various input/output devices and/or other components), in other embodiments. Additionally, in some embodiments, one or more of the illustrative components may be incorporated in, or otherwise form a portion of, another component.

The compute engine 200 may be embodied as any type of device or collection of devices capable of performing the various compute functions as described herein. In some embodiments, the compute engine 200 may be embodied as a single device such as an integrated circuit, an embedded system, a field-programmable-array (FPGA), a system-on-a-chip (SOC), an application specific integrated circuit (ASIC), reconfigurable hardware or hardware circuitry, or other specialized hardware to facilitate performance of the functions described herein. Additionally, in some embodiments, the compute engine 200 may include, or may be embodied as, one or more processors 202 and memory 206.

The processors 202 may be embodied as any type of processor capable of performing the functions described herein. For example, the processors 202 may be embodied as one or more multi-core processors, digital signal processors (DSPs), microcontrollers, or other processor(s) or processing/controlling circuit(s). In some embodiments, the processors 202 may be embodied as, include, or otherwise be coupled to a FPGA, an ASIC, reconfigurable hardware or hardware circuitry, or other specialized hardware to facilitate performance of the functions described herein. The illustrative processors 202 include multiple processor cores 204 (e.g., two processor cores, four processor cores, eight processor cores, sixteen processor cores, etc.).

Each of the processor cores 204 may be embodied as an independent logical execution unit capable of executing programmed instructions. It should be appreciated that, in some embodiments, the compute device 106 (e.g., in supercomputer embodiments) may include thousands of processor cores. Each of the processors 202 may be connected to a physical connector, or socket, on a motherboard (not shown) of the compute device 106 that is configured to accept a single physical processor package (i.e., a multi-core physical integrated circuit). Typically, each the processor cores 204 is communicatively coupled to at least a portion of a cache memory and includes functional units usable to independently execute programs, operations, threads, etc.

The memory 206 may be embodied as any type of volatile or non-volatile memory, or data storage capable of performing the functions described herein. It should be appreciated that the memory 206 may include main memory (i.e., a primary memory) and/or cache memory (i.e., memory that can be accessed more quickly than the main memory). It should be further appreciated that the volatile memory may be a storage medium that requires power to maintain the state of data stored by the medium. Non-limiting examples of volatile memory may include various types of random access memory (RAM), such as dynamic random access memory (DRAM) or static random access memory (SRAM).

The compute engine 200 is communicatively coupled to other components of the compute device 106 via the I/O subsystem 208, which may be embodied as circuitry and/or components to facilitate input/output operations with the processor 202, the memory 206, and other components of the compute device 106. For example, the I/O subsystem 208 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some embodiments, the I/O subsystem 208 may form a portion of a system-on-a-chip (SoC) and be incorporated, along with one or more of the processor 202, the memory 206, and other components of the compute device 106, on a single integrated circuit chip.

The one or more data storage devices 210 may be embodied as any type of storage device(s) configured for short-term or long-term storage of data, such as, for example, memory devices and circuits, memory cards, hard disk drives, solid-state drives, or other data storage devices. Each data storage device 210 may include a system partition that stores data and firmware code for the data storage device 210. Each data storage device 210 may also include an operating system partition that stores data files and executables for an operating system.

The communication circuitry 212 may be embodied as any communication circuit, device, or collection thereof, capable of enabling communications between the compute device 106 and the network compute device 104, other compute devices 106, as well as any network communication enabling devices, such as an access point, router, etc., to allow communication to/from the compute device 106. Accordingly, the communication circuitry 212 may be configured to use any wireless and/or wired communication technologies and associated protocols (e.g., Ethernet, Bluetooth®, Wi-Fi®, WiMAX, LTE, 5G, etc.) to effect such communication. It should be appreciated that, in some embodiments, the communication circuitry 212 may include specialized circuitry, hardware, or combination thereof to perform pipeline logic (e.g., hardware-based algorithms) for performing the functions described herein, including processing network packets, making routing decisions, performing computational functions, etc.

In some embodiments, performance of one or more of the functions of communication circuitry 212 as described herein may be performed by specialized circuitry, hardware, or combination thereof of the communication circuitry 212, which may be embodied as a system-on-a-chip (SoC) or otherwise form a portion of a SoC of the compute device 106 (e.g., incorporated on a single integrated circuit chip along with a processor 202, the memory 206, and/or other components of the compute device 106). Alternatively, in some embodiments, the specialized circuitry, hardware, or combination thereof may be embodied as one or more discrete processing units of the compute device 106, each of which may be capable of performing one or more of the functions described herein.

The illustrative communication circuitry 212 includes a multi-homed NIC 214. The multi-homed NIC 214 may be embodied as one or more add-in-boards, daughtercards, network interface cards, controller chips, chipsets, or other devices that may be used by the compute device 106. For example, in some embodiments, the multi-homed NIC 214 may be integrated with one or more processors 202, embodied as an expansion card coupled to the I/O subsystem 208 over an expansion bus (e.g., PCI Express), part of a SoC that includes one or more processors 202, or included on a multichip package that also contains one or more processors 202. Additionally or alternatively, in some embodiments, functionality of the multi-homed NIC 214 may be integrated into one or more components of the compute device 106 at the board level, socket level, chip level, and/or other levels.

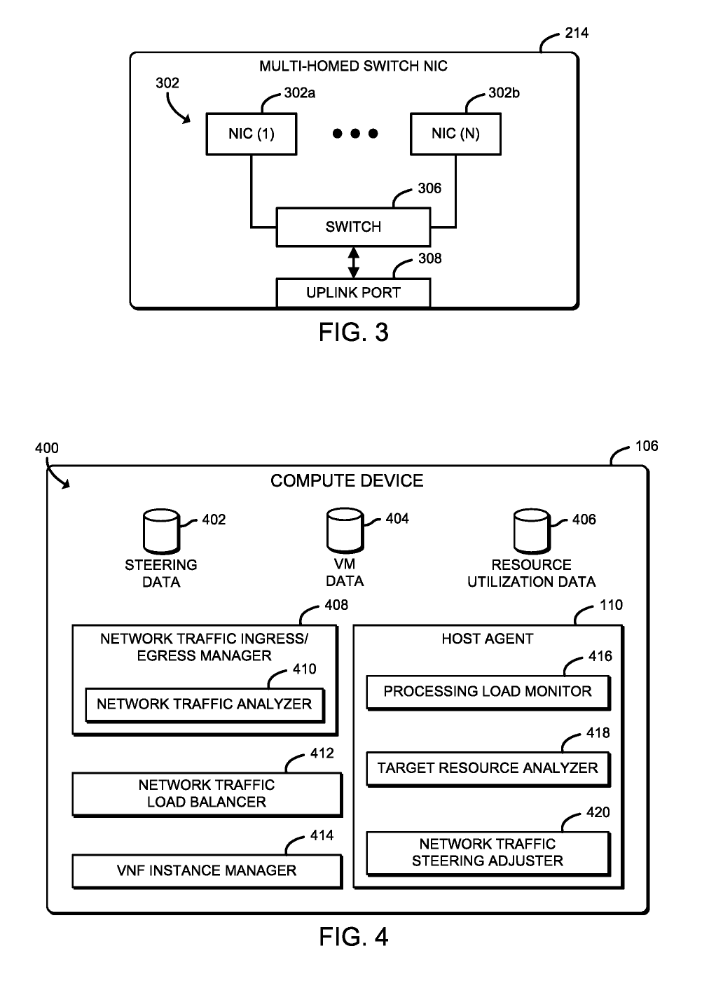

Referring now to FIG. 3, an illustrative multi-homed NIC 214 is shown that includes a plurality of network interface controllers 302, a switch 306, and an uplink port 308. The illustrative multi-homed NIC 222 is a physical NIC that includes the network interface controllers 302, which may be embodied as physical and/or logical NICs 302. The illustrative NICs 302 include a first NIC 302 designated as NIC (1) 302a and a second NIC 302 designated as NIC (N) 302b, in which “N” is a positive integer and represents the “Nth” NIC 302. The uplink port 308 is configured to connect the multi-homed NIC 214 to other computing devices for the purpose of receiving/forwarding network packets. The switch 306, which may be embodied as a physical or logical switch, is communicatively coupled to each of the NICs 302a, 302b and is configured to transmit network packets to/from the NICs 302 and the uplink port 308.

In some embodiments, the multi-homed NIC 214 may include other components which are not shown for clarity of the description, such as a processor, an accelerator device (e.g., any type of specialized hardware on which operations can be performed faster and/or more efficiently than is possible on the local general-purpose processor), and/or memory. It should be appreciated that, in such embodiments, the local processor and/or accelerator device of the multi-homed NIC 214 may be capable of performing one or more of the functions described herein. In some embodiments, each of the NICs 302 may be communicatively coupled to a non-uniform memory access (NUMA) node or some other host interface to allow for network packet data to be transferred to/from the host processors 202 for processing.

Referring back to FIG. 2, the one or more peripheral devices 216 may include any type of device that is usable to input information into the network compute device 104 and/or receive information from the compute device 106. The peripheral devices 216 may be embodied as any auxiliary device usable to input information into the compute device 106, such as a keyboard, a mouse, a microphone, a barcode reader, an image scanner, etc., or output information from the compute device 106, such as a display, a speaker, graphics circuitry, a printer, a projector, etc. It should be appreciated that, in some embodiments, one or more of the peripheral devices 216 may function as both an input device and an output device (e.g., a touchscreen display, a digitizer on top of a display screen, etc.). It should be further appreciated that the types of peripheral devices 216 connected to the compute device 106 may depend on, for example, the type and/or intended use of the compute device 106. Additionally or alternatively, in some embodiments, the peripheral devices 216 may include one or more ports, such as a USB port, for example, for connecting external peripheral devices to the compute device 106.

Referring back to FIG. 1, the network 102 may be embodied as any type of wired or wireless communication network, including but not limited to a wireless local area network (WLAN), a wireless personal area network (WPAN), an edge network (e.g., a multi-access edge computing (MEC) network), a fog network, a cellular network (e.g., Global System for Mobile Communications (GSM), Long-Term Evolution (LTE), 5G, etc.), a telephony network, a digital subscriber line (DSL) network, a cable network, a local area network (LAN), a wide area network (WAN), a global network (e.g., the Internet), or any combination thereof. It should be appreciated that, in such embodiments, the network 102 may serve as a centralized network and, in some embodiments, may be communicatively coupled to another network (e.g., the Internet). Accordingly, the network 102 may include a variety of other virtual and/or physical computing devices (e.g., routers, switches, network hubs, servers, storage devices, compute devices, etc.), as needed to facilitate the transmission of network traffic through the network 102.

The network compute device 104 may be embodied as any type of network traffic processing device that is capable of performing the functions described herein, such as, without limitation, a server (e.g., stand-alone, rack-mounted, blade, etc.), a network appliance (e.g., physical or virtual), a switch (e.g., rack-mounted, standalone, fully managed, partially managed, full-duplex, and/or half-duplex communication mode enabled, etc.), a router, a web appliance, a distributed computing system, a processor-based system, and/or a multiprocessor system. It should be appreciated that each of the network compute device 104 typically includes similar and/or like components to that of the illustrative compute device 106 described above. As such, the descriptions of the like or similar components are not repeated herein for clarity of the description with the understanding that the description of the corresponding components provided above in regard to the illustrative compute device 106 of FIG. 2 applies equally to the corresponding components of the network compute device 104. Of course, it should be appreciated that the network compute device 104 may include additional and/or alternative components, depending on the embodiment.

Referring now to FIG. 4, in use, the compute device 106 establishes an environment 400 during operation. The illustrative environment 400 includes a network traffic ingress/egress manager 408, a network traffic load balancer 412, and a VNF instance manager 414, as well as the host agent 110 of FIG. 1. The various components of the environment 400 may be embodied as hardware, firmware, software, or a combination thereof. As such, in some embodiments, one or more of the components of the environment 400 may be embodied as circuitry or collection of electrical devices (e.g., network traffic ingress/egress management circuitry 408, network traffic load balancing circuitry 412, VNF instance management circuitry 414, host agent circuitry 110, etc.). It should be appreciated that, in such embodiments, one or more of the circuits (e.g., the network traffic ingress/egress management circuitry 408, the network traffic load balancing circuitry 412, the VNF instance management circuitry 414, the host agent circuitry 110, etc.) may form a portion of one or more of the compute engine 200 (i.e., the processors 202 and/or the memory 206), the I/O subsystem 208, the communication circuitry 212, the data storage device(s) 210, an ASIC, an FPGA, and/or other components of the compute device 106.

For example, any of the circuitry (e.g., the network traffic ingress/egress management circuitry 408, the network traffic load balancing circuitry 412, the VNF instance management circuitry 414, the host agent circuitry 110, etc.) may be embodied as at least a portion of the compute engine 200 and associated instructions stored in the memory 206 and/or the data storage device(s) 210, which may be executed by the processors 202. Accordingly, it should be appreciated that, each of the functions described herein as being performed by the network traffic ingress/egress management circuitry 408, the network traffic load balancing circuitry 412, the VNF instance management circuitry 414, and/or the host agent circuitry 110 may be performed, at least in part, by one or more components of the compute device 106, such as the compute engine 200, the I/O subsystem 208, the communication circuitry 212, and/or other components of the compute device 106.

Additionally, in some embodiments, one or more of the illustrative components may form a portion of another component and/or one or more of the illustrative components may be independent of one another. Further, in some embodiments, one or more of the components of the environment 400 may be embodied as virtualized hardware components or emulated architecture, which may be established and maintained by the compute engine 200 or other components of the network compute device 104. It should be appreciated that the network compute device 104 may include other components, sub-components, modules, sub-modules, logic, sub-logic, and/or devices commonly found in a computing device, which are not illustrated in FIG. 4 for clarity of the description.

In the illustrative environment 400, the compute device 106 additionally includes steering data 402, VM data 404, and resource utilization data 406, each of which may be accessed by the various components and/or sub-components of the compute device 106. Additionally, it should be appreciated that in some embodiments the data stored in, or otherwise represented by, each of the steering data 402, the VM data 404, and the resource utilization data 406 may not be mutually exclusive relative to each other. For example, in some implementations, data stored in the steering data 402 may also be stored as a portion of one or more of the VM data 404 and/or the resource utilization data 406. As such, although the various data utilized by the compute device 106 is described herein as particular discrete data, such data may be combined, aggregated, and/or otherwise form portions of a single or multiple data sets, including duplicative copies, in other embodiments.

The network traffic ingress/egress manager 408, which may be embodied as hardware, firmware, software, virtualized hardware, emulated architecture, and/or a combination thereof as discussed above, is configured to receive inbound and route/transmit outbound network traffic. To do so, the network traffic ingress/egress manager 408 is configured to facilitate inbound/outbound network communications (e.g., network traffic, network packets, network flows, etc.) to and from the compute device 106. For example, the network traffic ingress/egress manager 408 is configured to manage (e.g., create, modify, delete, etc.) connections to physical ports (e.g., the uplink port 308 of the multi-homed NIC 214 of FIG. 3) and virtual network ports (i.e., virtual network interfaces) of the compute device 106, as well as the ingress/egress buffers/queues associated therewith.

The illustrative network traffic ingress/egress manager 408 includes a network traffic analyzer 410 that is configured to analyze network traffic such that a steering decision can be made thereon. For example, in some embodiments, the network traffic analyzer 410 may be configured to sample or otherwise analyze a portion of the network packet (e.g., one or more header fields, at least a portion of the payload, etc.) to detect a flow, workload type, source, destination, etc., such that a result of the analysis can be used to trigger a steering decision to steer the network traffic to the appropriate VNF. Depending on the embodiments, the level and/or type of analysis performed on the network traffic may be provided by a policy, script, or other set of rules usable by the network traffic analyzer 410 to appropriately analyze the network traffic. In some embodiments, the rules may be determined locally by control plane logic, while in other embodiments the rules may be provided from a remote network controller device (see, e.g., the network controller 108 of FIG. 1), such by as a software defined network (SDN) controller in SDN architectures.

The network traffic load balancer 412, which may be embodied as hardware, firmware, software, virtualized hardware, emulated architecture, and/or a combination thereof as discussed above, is configured to balance the network traffic load between available VNFs to perform processing operations on received network traffic. To do so, the network traffic load balancer 412 is configured to identify one or more properties of the network traffic (e.g., as determined based on an analysis thereof performed by the network traffic analyzer 410) and determine which one or more operations are to be performed on at least a portion of the network packet. Additionally, the network traffic load balancer 412 is configured to determine a target VNF from the available VNFs to perform at least one of the determined network packet processing operations. The network traffic load balancer 412 is further configured to update access control lists (ACLs) to redirect network traffic (e.g., subscriber-based network traffic flows). It should be appreciated that alternative techniques may be used steer the network traffic in other embodiments. In some embodiments, the ACLs and/or other steering related data may be stored in the steering data 402.

The VNF instance manager 414, which may be embodied as hardware, firmware, software, virtualized hardware, emulated architecture, and/or a combination thereof as discussed above, is configured to create and configure VNFs to perform various network packet data processing services. For example, the various network packet data processing VNFs may include firewall services, network address translation (NAT) services, deep packet inspection (DPI) services, evolved packet core (EPC) services, mobility management entity (MME) services, packet data network gateway (PGW) services, serving gateway (SGW) services, billing services, transmission control protocol (TCP) optimization services, etc. Depending on the embodiment, the VNF instance manager 414 may be configured to create and configure the VNFs based on a network policy, script, or other set of rules. In some embodiments, information associated with the underlying processing components of the VNFs, such as the one or more VMs, processing cores, etc., are stored in the VM data 404. For example, VM identification data, VNF to VM mapping data, etc., may be stored in the VM data 404.

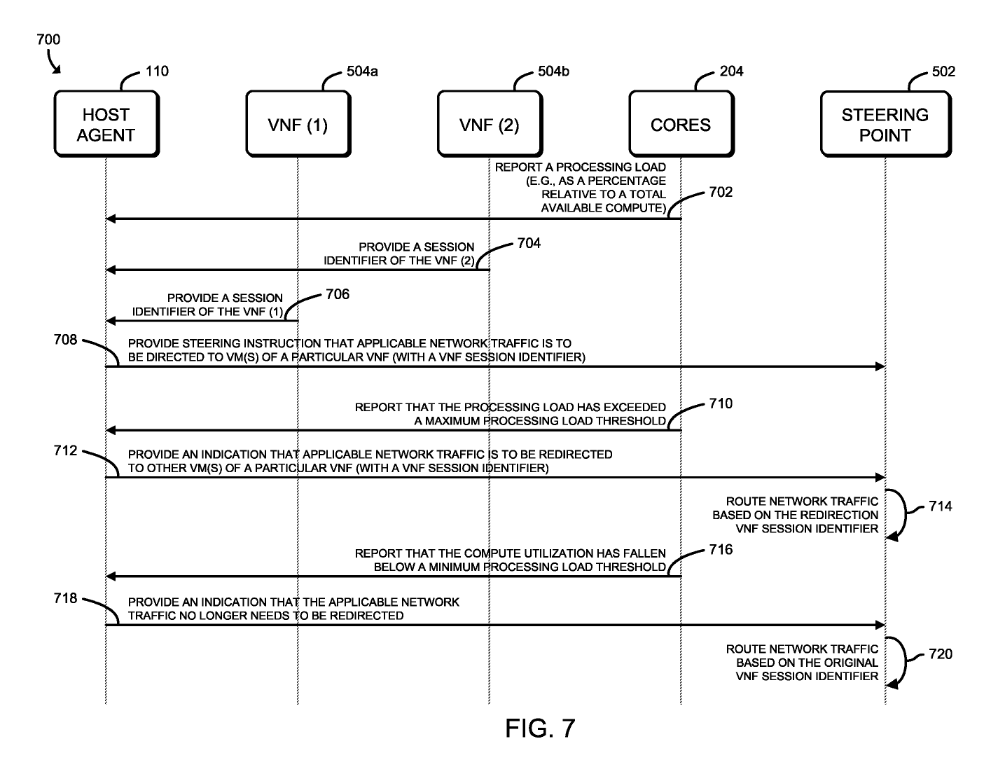

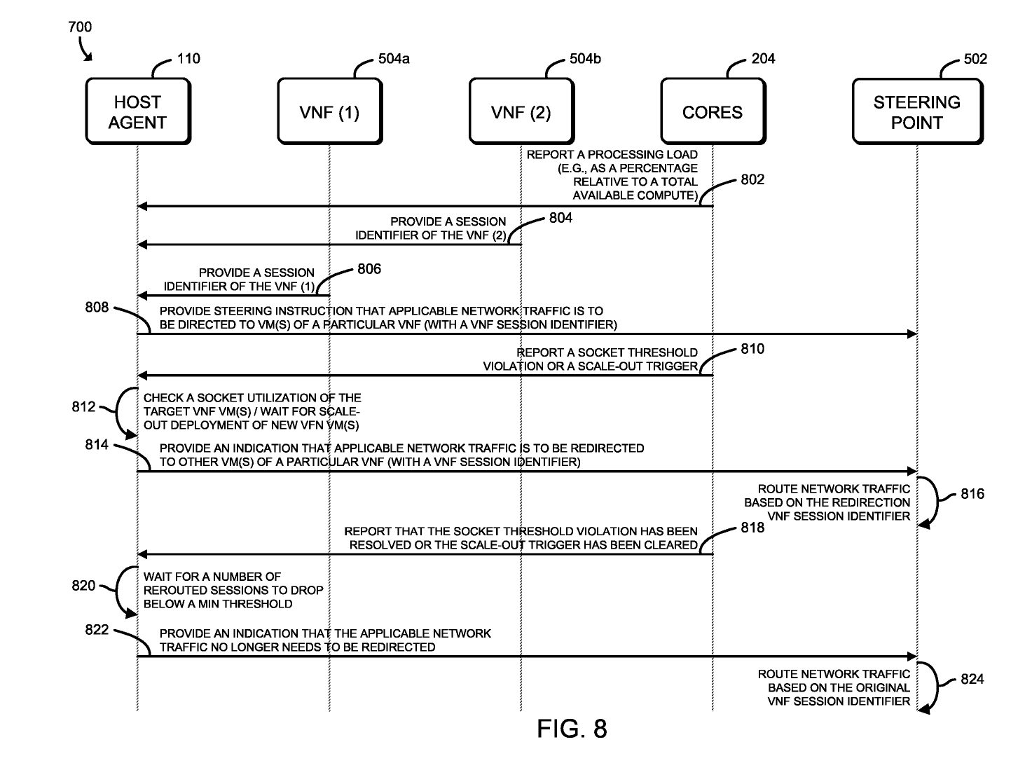

The host agent 110 is configured to determine whether to reroute steering decisions from originally targeted VM(s)/processing core(s) of the target VNF (e.g., as determined by the network traffic load balancer 412) to other VMs/processing cores of the target VNF (see, e.g., the communication flow 700 of FIG. 7) or to VM(s)/processing core(s) of another available VNF (see, e.g., the communication flow 800 of FIG. 8). To do so, the illustrative host agent 110 includes a processing load monitor 416, a target resource analyzer 418, and a network traffic steering adjuster 420. The processing load monitor 416 is configured to monitor a processing load for each of the VNFs. To do so, the processing load monitor 416 is configured to receive processing load information from each of the VMs and/or processing cores (e.g., the processing cores 204 of FIG. 2) associated with each VNF. The processing load information may include any type of data usable to identify an amount of compute resources being utilized at a given point in time, such as processor utilization statistics/metrics, Intelligent Platform Management Interface statistics, etc.

It should be appreciated that, depending on the embodiment, additional and/or alternative resource utilization metric(s) may be used to determine whether a steering redirection is appropriate. In an illustrative embodiment, memory thermal throttling (i.e., related to a memory thermal management system (not shown)) may be used. In such embodiments, thermal conditions of the memory (e.g., the memory 206 of FIG. 2) may restrict read and write traffic/bandwidth to the memory 206 as a means of controlling power consumption. It should be appreciated that the memory thermal throttling metric can be measured as a percentage, wherein 0% indicates that no memory throttling occurs.

However, as thermal conditions rise, the memory thermal management system may enable throttling and restrict the read or write traffic (e.g. 50%). Depending on the embodiment, when memory thermal throttling reaches a memory throttling threshold percentage, the host agent 110 may take remedial action and initiate the redirection of network traffic to other VM(s) or the target VNF or another VNF to which the network traffic is to be redirected. In some embodiments, the processing load information and/or other resource utilization metrics may be stored in the resource utilization data 406.

The target resource analyzer 418 is configured to analyze the processing load information received from the VNFs and their respective VMs/processing cores to determine whether a potential overload or some other resource limiting event is likely to occur such that would likely result in dropped packets if the network traffic were steered to the target VNF as originally intended. For example, the target resource analyzer 418 may be configured to determine whether the processing load information exceeds or falls below a particular threshold, and initiate a subsequent action (e.g., by the network traffic steering adjuster 420) to be taken in response to having made such a determination. The target resource analyzer 418 is further configured to determine whether additional resources are required to initiate the subsequent action. For example, target resource analyzer 418 may determine that additional to VMs need to be spun up for a new or existing VNF in order to support the processing required by the received network traffic.

The network traffic steering adjuster 420 is configured to adjust the initial steering direction to the target VNF. As described previously, the steering direction may be changed to direct the network traffic to be processed to different VM(s)/processing core(s) of the target VNF or to new/cold VM(s)/processing core(s) of another VNF. To do so, the network traffic steering adjuster 420 is configured update an ACL to include session identifiers for the VNFs which are usable to map the network traffic to the intended VNFs. In some embodiments, the ACLs, VNF session identifiers, and/or other steering information may be stored in the steering data 402.

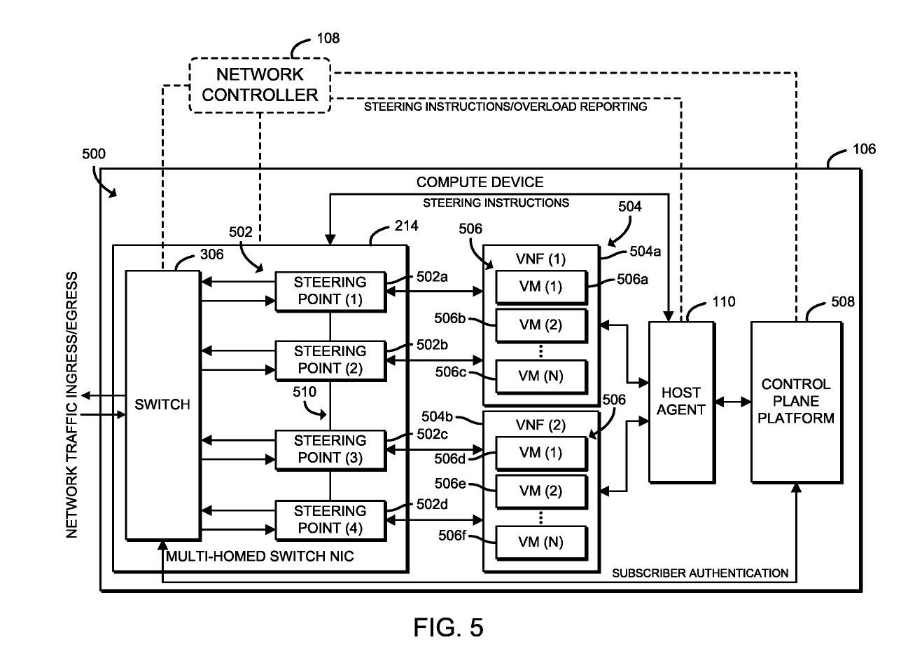

Referring now to FIG. 5, in use, the compute device 106 establishes an environment 500 during operation. The illustrative environment 500 includes the multi-homed switch NIC 214 of FIG. 2, multiple VNFs 504, and a control plane platform 508, as well as the network controller 108 and the host agent 110 of FIG. 1. The illustrative multi-homed switch NIC 214 includes the switch 306 of FIG. 3, as well as multiple steering points 502. Each of the steering points 502 may be embodied as any type of software, hardware, firmware, or combination thereof that is capable of performing the functions described herein, including receiving network traffic from the switch 306 and appropriately steering or otherwise directing the received network traffic to the applicable resources (e.g., VM(s), processor core(s), etc.) of the target VNF.

The illustrative steering points 502 includes a first steering point designated as steering point (1) 502a, a second steering point designated as steering point (2) 502b, a third steering point designated as steering point (3) 502c, and a fourth steering point designated as steering point (4) 502c. Depending on the embodiment, each of the multiple steering points 502 may be included on a separate NIC (e.g., a separate one of the NICs 302 of FIG. 3). In other words, in such embodiments, the steering point (1) 502a may reside on one NIC 302 (e.g., the NIC 302a), the steering point (2) 502b may reside on another NIC 302 (e.g., the NIC 302b), etc. It should be appreciated that, irrespective of the implementation, each steering point 502 is above low-level queue assignment, differentiating it from other load rebalancing techniques, such as receive side scaling (RSS). Each of the steering points 502 is illustratively shown as being communicatively coupled to at least one other steering point 502 via an interconnect/bus 510, such as an Intel® QuickPath Interconnect.

As illustratively shown, each of the steering points 502 is communicatively coupled to a VNF 504. The illustrative VNFs 504 include one VNF designated as VNF 504a and another VNF designated as VNF 504b. While not illustratively shown, it should be appreciated that each of the VNFs 504 are deployed on separate processor sockets of the compute device 106. However, it should be further appreciated that other embodiments may include multiple VNFs 504 deployed on a single processor 202. Additionally, while only two VNFs 504 are illustratively shown, it should be appreciated that multiple VNFs 504 may be present in other embodiments.

The illustrative VNF (1) 504a includes multiple VMs 506, including a first VM designated as VM (1) 506a, a second VM designated as VM (2) 506b, and a third VM designated as VM (N) 506c (e.g., in which the VM (N) 506c represents the “Nth” VM 506 of the VNF (1) 504a and “N” is a positive integer). Similarly, the VNF (2) 504b includes multiple VMs 506, including a first VM designated as VM (1) 506d, a second VM designated as VM (2) 506e, and a third VM designated as VM (N) 506f (e.g., in which the VM (N) 506f represents the “Nth” VM 506 of the VNF (2) 506 and “N” is a positive integer).

The VNF (1) 504a is illustratively shown as being communicatively coupled to the steering point (1) 502a and the steering point (2) 504b, while the VNF (2) 504b is illustratively shown as being communicatively coupled to the steering point (3) 502c and the steering point (4) 502d. Accordingly, it should be appreciated that if network traffic intended to be routed to the VNF (1) 504a is received by the switch 306, the switch 306 is likely to determine that either of the steering point (1) 502a or the steering point (2) 502b should be the intended recipient. However, depending on the conditions affecting the resources of the compute device 106 at any given time, the target VNF may be intra or inter-socket, via an interconnected front-end of the multi-homed switch NIC 214.

It should be appreciated that, for inter-socket load-aware traffic steering, the inter-socket interconnect 510 is not traversed and thus introduce bottlenecks, latency, and non-deterministic performance issues. It should be further appreciated that each of the steering points 502 is configured to steer the network traffic to a particular one or more of the VM(s) 506 of the associated VNF 504. For example, the steering point (1) 502a may be configured to steer network traffic to the VM (1) 506a of the VNF (1) 504a, while the steering point (2) 502b may be configured to steer network traffic to the VM (2) 506b of the VNF (1) 504a.

The control plane platform 508, which may be embodied as hardware, firmware, software, virtualized hardware, emulated architecture, and/or a combination thereof, is configured to manage the control plane logic of the compute device 106. To do so, the control plane platform 508 is configured to setup connections to other computing devices (e.g., via the network compute device 104), authenticate subscriber connections (e.g., Point-to-Point Protocol over Ethernet (PPPoE) subscriber identifiers, GPRS Tunneling Protocol (GTP) (e.g., GTP-C) subscriber identifiers, etc), and manage the routing of network traffic to/from the compute device 106, as well as through the compute device 106 fabric.

Additionally, the control plane platform 508 may be configured to describe how to classify and steer ingress network traffic. The control plane platform 508 is further configured to manage the VNF session identifiers (i.e., VNF-specific session identifiers as provided by the VNFs) and provide the VNF session identifiers to the host agent 110 for steering. As described previously, at least a portion of the logic described herein as being performed by the control plane platform 508 may be performed by a remote network controller 108. Accordingly, in such embodiments, the VNF session identifiers may be forwarded to the network controller, such that the network controller can manage the switching performed by the switch 306.

In some embodiments, the compute device 106 may be deployed in an architecture in which a network controller 108 provides control plane information usable to make traffic steering decisions. For example, in SDN architectures, an externally located network controller, referred to as an SDN controller, is connected to networked compute/storage/switching/routing devices to make the network traffic flow logic decisions for the network packets across the network and/or across the compute device 106 fabric, a task traditionally performed at the compute device 106 level. In such embodiments, the SDN controller typically serves as a centralized network management application that provides an abstracted control plane for managing configurations of the compute devices 160 from a remote location.

As such, network packet processing (e.g., network traffic flow logic, processing operations/services to be performed thereon, etc.) previously performed on dedicated network processors of the compute devices 106 may now be processed on general purpose processors, thereby reducing the complexity of the hardware components necessary for compute devices 106 deployed in a software-defined network and enabling deployment of new software-based features independently of hardware release cycle. Accordingly, in such embodiments, the network controller 108 may be configured to provide the policies, rules, etc., used by the network traffic ingress/egress manager 410, the network traffic load balancer 412, the VNF instance manager 414, and/or the host agent 110 of FIG. 4.

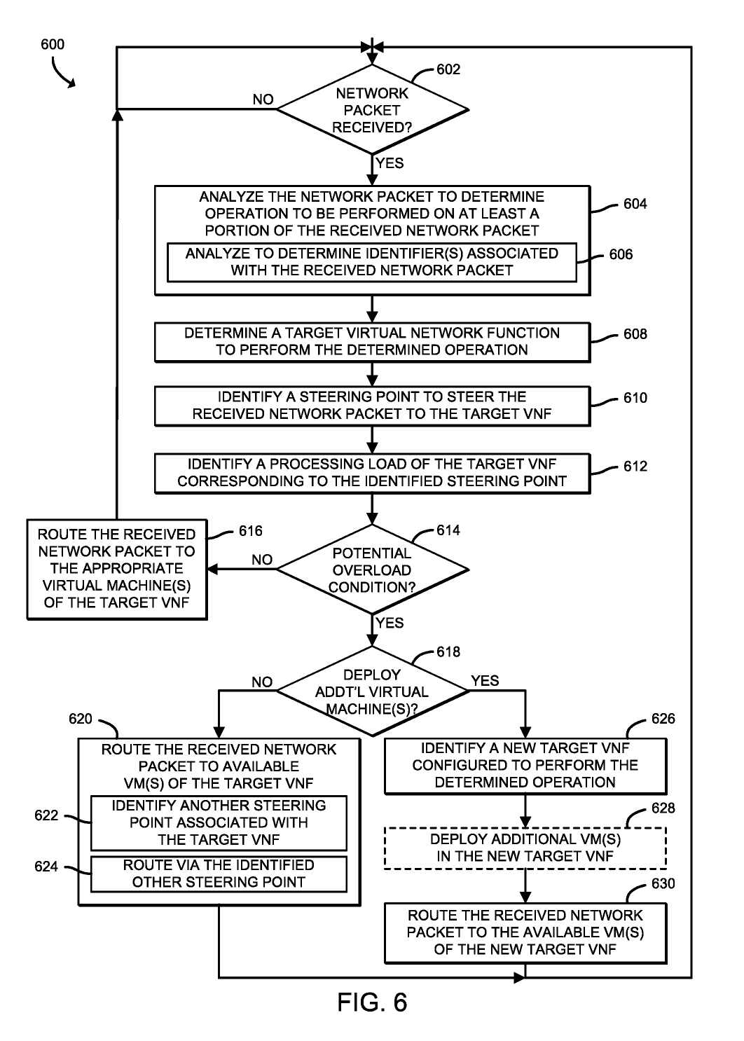

Referring now to FIG. 6, a method 600 for load-aware traffic steering is shown that may be executed by a compute device 106, or more particularly by one or more components of the compute device 106, such as those components described herein in FIGS. 2-4. The method 600 begins with block 602, in which the compute device 106 determines whether a network packet has been received. If so, the method 600 advances to block 604, in which the compute device 106 analyzes the network packet to determine one or more processing operations to be performed on at least a portion of the received network packet. For example, in block 606, the compute device 106 analyzes the network packet to determine one or more identifiers associated with the received network packet (e.g., a flow, a workload type, etc.).

In block 608, the compute device 106 determines a target VNF (e.g., one of the VNFs 504 of FIG. 5) to perform the determined operations based on the analysis of the received network packet. In block 610, the compute device 106 identifies a steering point (e.g., one of the VNFs 504 of FIG. 5) of a NIC (e.g., one of the NIC 302 of FIG. 3) of the compute device 106 to steer the received network packet, or at least a portion thereof, to the target VNF. In block 612, the compute device 106 identifies a processing load of the target VNF. As described previously, the processing load may be associated with one or more VMs (e.g., one or more of the VMs 506), one or more processing cores, and/or any other resource allocated to the target VNF corresponding to the identified steering point. As also described previously, the component resources (e.g., processing cores associated with the VMs, the VMs individually, etc.) may report a present processing load (e.g., upon request, at a given interval, etc.). In block 614, the compute device 106 determines whether the identified processing load indicates that a potential overload condition has been detected. For example, the compute device 106 may compare the received processing load to a maximum processing load threshold, such that a potential overload condition exists if the received processing load exceeds the maximum processing load threshold (e.g., at any point, for a given period of time, etc.).

If the compute device 106 determines that a potential overload condition has not been detected, the method 600 branches to block 616, in which the compute device 106 routes the received network packet to the appropriate determined VM(s) of the target VNF. Otherwise, if the compute device 106 determines that a potential overload condition has been detected, the method 600 branches to block 618. In block 618, the compute device 106 determines whether to deploy any additional VMs (e.g., of another VNF instance) to process at least a portion of the received network packet.

If not, the method 600 branches to block 620, in which the compute device 106 routes the received network packet, or at least a portion thereof, to the available VM(s) of the target VNF. To do so, in block 622, the compute device 106 identifies another steering point of another NIC (e.g., another one of the NICs 302 of FIG. 3) associated with the target VNF. Additionally, in block 624, the compute device 106 routes (e.g., updates the ACLs) the received network packet to the available VM(s) of the target VNF via the identified other steering point. It should be appreciated that, under certain conditions, the compute device 106 may route the received network packet via another steering point directed to available VM(s) of another VNF whose present processing load does not indicate a potential overload condition.

Referring again to block 618, if the compute device 106 determines to deploy one or more additional VMs (e.g., of another VNF instance) for processing the received network packet, the method 600 branches to block 626. In block 626, the compute device 106 identifies a new target VNF, or more particularly another VNF whose present processing load does not indicate a potential overload condition, that is configured to perform the determined operation to process at least a portion of the received network packet. Under certain conditions, the identified new target VNF may not have sufficient resources to process the network packet. Accordingly, under such conditions, in block 628, the compute device 106 may deploy one or more additional VM(s) in the new target VNF.

In block 630, the compute device 106 routes (e.g., updates the ACLs) the received network packet, or at least a portion thereof, to the available VM(s) of the new target VNF. It should be appreciated that routing the received network packet includes identifying the appropriate steering point another steering point of another NIC (e.g., another one of the NICs 302 of FIG. 3) associated with the available VM(s) of the new target VNF. It should be further appreciated that at least a portion of the method 600 may be iterated through for multiple processing operations to be performed on at least a portion of the received network packet, such as in a service function chain.

Referring now to FIG. 7, an illustrative communication flow 700 for intra-socket load-aware traffic steering is shown that may be executed by a compute device 106, or more particularly by one or more components of the compute device 106, such as those components described herein in FIGS. 2-4. The illustrative communication flow 700 includes the host agent 110, the VNF (1) 504a, the VNF (2) 504b, the processor cores 204, and a steering point 502 (e.g., one of the steering points 502 of FIG. 5). It should be appreciated that the illustrative communication flow 700 includes a number of data flows, some of which may be executed separately or together, depending on the respective data flow and the embodiment. In data flow 702, the host agent 110 receives an indication of a current processing load from the processor cores 204. For example, the processor cores 204 may report the processing load as a percentage relative to a total available compute. In data flow 704, host agent 110 receives, from the VNF (2) 504b, a session identifier of the VNF (2) 504b. Similarly, in data flow 706, the home agent 110 receives, from the VNF (1) 504a, a session identifier of the VNF (1) 504a.

In data flow 708, the host agent 110 provides a steering instruction to the steering point 502 (e.g., by updating the ACL and notifying the steering point 502) that is usable by the steering point 502 to steer applicable network traffic (e.g., network traffic associated with new subscriber sessions) to instantiated VMs of a VNF to which the steering point 502 corresponds. Accordingly, it should be appreciated that the steering instruction includes the applicable session identifiers of the VNF 504 (e.g., the VNF (1) 504a) corresponding to the steering point 502. In some embodiments, the steering instruction may include a message indicating that an applicable table (e.g., ACL list, hash table, etc.) has been updated to include an updated list of the VNFs (i.e., using the session identifiers of the VNFs) corresponding to the steering point 502. In data flow 710, the host agent 110 receives an indication from the processor cores 204 that the processing load has exceeded a maximum processing load threshold. Alternatively, in other embodiments, the present processing load may be received by a monitoring component of the host agent 110 (e.g., the processing load monitor 416) that is usable by the host agent 110 to make the determination that the processing load has exceeded a maximum processing load threshold.

In data flow 712, the host agent 110 provides an indication to the steering point 502 that indicates applicable network traffic is to be redirected to other VMs (e.g., by updating the ACL and notifying the steering point 502) of a particular VNF. It should be appreciated that the other VMs the network traffic is being redirected to may reside in the same target VNF or another VNF. The indication additionally includes a VNF session identifier of the VNF that includes the VMs that the network traffic is to be redirected to. It should be appreciated that the steering point 502 is configured to redirect the network traffic to another steering point 502 that may be configured to steer the network traffic to other VMs of the target VNF or other VMs of another VNF. In data flow 714, the steering point 502 routes the network traffic based on the redirection VNF session identifier.

In data flow 716, the host agent 110 receives a report that the compute utilization has fallen below a minimum processing load threshold. Alternatively, in other embodiments, the present processing load may be received by a monitoring component of the host agent 110 (e.g., the processing load monitor 416) that is usable by the host agent 110 to make the determination that the processing load has fallen below the minimum processing load threshold. In some embodiments, the processing load may be required to stay below the minimum processing load threshold for a minimum duration of time. In data flow 718, the host agent 110 provides an indication to the steering point 502 that the applicable network traffic no longer needs to be redirected (e.g., by updating the ACL and notifying the steering point 502). Accordingly, in data flow 720, the steering point routes the network traffic based on the originally received VNF session identifier.

In an illustrative example of the illustrative communication flow 700 for intra-socket load-aware traffic steering, referring back to FIG. 5, network traffic may be received at the switch 306 that is to be routed to steering point (1) 502a and steering point (1) 502a is configured to steer the network traffic to be processed by the VM (1) 506a of the VNF (1) 504a. If conditions exist such that the processing load of the processor core(s) 204 allocated to the VM (1) 506a exceeds the maximum minimum processing load threshold, the host agent 110 is configured to provide an indication (e.g., via an ACL update) to the steering point (1) 502a that the network traffic to be processed by the VM (1) 506a of the VNF (1) 504a is to be redirected to the steering point (2) 502a (e.g., via the interconnect 510) to be processed by the VM (2) 506b of the VNF (1) 504a.

Referring now to FIG. 8, an illustrative communication flow 700 for inter-socket load-aware traffic steering is shown that may be executed by a compute device 106, or more particularly by one or more components of the compute device 106, such as those components described herein in FIGS. 2-4. The illustrative communication flow 700 includes the host agent 110, the VNF (1) 504a, the VNF (2) 504b, the processor cores 204, and a steering point 502. It should be appreciated that the illustrative communication flow 700 includes a number of data flows, some of which may be executed separately or together, depending on the respective data flow and the embodiment.

In data flow 802, the host agent 110 receives an indication of a current processing load from the processor cores 204. As described previously, the processor cores 204 may report the processing load as a percentage relative to a total available compute. As also described previously, additional and/or alternative resource utilization metrics may be used in other embodiments, such as a memory throttling percentage. In data flow 804, host agent 110 receives, from the VNF (2) 504b, a session identifier of the VNF (2) 504b. Similarly, in data flow 806, the home agent 110 receives, from the VNF (1) 504a, a session identifier of the VNF (1) 504a.

In data flow 808, the host agent 110 provides steering instruction to the steering point 502 (e.g., by updating the ACL and notifying the steering point 502) that is usable by the steering point 502 to steer applicable network traffic (e.g., network traffic associated with new subscriber sessions) to instantiated VMs of a VNF to which the steering point 502 corresponds. Accordingly, it should be appreciated that the steering instruction includes the applicable session identifiers of the VNF 504 (e.g., the VNF (1) 504a) corresponding to the steering point 502. In some embodiments, the steering instruction may include a message indicating that an ACL or other steering indication table has been updated to include an updated list of the VNFs (i.e., using the session identifiers of the VNFs) corresponding to the steering point 502. In data flow 810, the host agent 110 receives an indication from the processor cores 204 that a socket threshold has been violated or a scale out trigger has been detected. As described previously, in other embodiments, the host agent 110 may receive or otherwise have access to the resource utilization data to make the determination that a socket threshold violation has occurred (e.g., the processing load has exceeded a maximum processing load threshold, the memory throttling percentage has exceeded a memory throttling threshold percentage, etc.).

Under certain conditions (e.g., based on a time-of-day load), one VNF may need more resources (e.g., compute, memory, etc.) than other VNFs. Under such conditions, the resource deficient VNF may scale out into another processor socket. Once complete and the new VMs are active on the other processor socket, the host agent 110 is configured to monitor VMs using the monitoring techniques described herein. Accordingly, network traffic may be steered effectively to the best processor resource, regardless of location on the compute device 106 or ingress traffic NIC (e.g., one of the NICs 302 of FIG. 3). It should be appreciated that the interconnect 510 can be bypassed for scale-out by leveraging the switch 306, and therefore should get more predictability and better performance post scale-out relative to steering decisions reliant on the interconnect 510.

In data flow 812, the host agent 110 checks a socket utilization level of the target VNF VMs and waits for the scale-out deployment of the new VNF VM(s) to complete. In data flow 814, the host agent 110 provides an indication to the steering point 502 that indicates applicable network traffic is to be redirected to other VMs (e.g., by updating the ACL and notifying the steering point 502) of a scale-out VNF. The indication additionally includes a VNF session identifier of the VNF that includes the VMs the network traffic is to be redirected to. It should be appreciated that the steering point 502 is configured to redirect the network traffic to another steering point 502, and that the other steering point 502 is configured to steer the network traffic to the scale-out VMs of the target scale-out VNF. In data flow 816, the steering point 502 routes the network traffic based on the redirection VNF session identifier.

In data flow 818, the host agent 110 receives a report that the socket threshold violation has been resolved or the scale-out trigger has been cleared. Alternatively, in other embodiments, as described previously, the host agent 110 may access one or more resource utilization metrics that are usable by the host agent 110 to make the determination that the socket threshold violation has been resolved (e.g., the processing load has fallen below the minimum processing load threshold, the memory throttling percentage has fallen below the memory throttling threshold percentage, etc.) or the scale-our trigger has been cleared. In data flow 820, the host agent 110 waits for a number of re-routed network traffic sessions to drop below a minimum threshold. In data flow 822, the host agent 110 provides an indication to the steering point 502 that the applicable network traffic no longer needs to be redirected (e.g., by updating the ACL and notifying the steering point 502). Accordingly, in data flow 824, the steering point routes the network traffic based on the originally received VNF session identifier.

In an illustrative example of the illustrative communication flow 700 for intra-socket load-aware traffic steering, referring again to FIG. 5, network traffic may be received at the switch 306 that is to be routed to steering point (2) 502b and steering point (2) 502b is configured to steer the network traffic to be processed by all of the VMs 506a, 506b, and 506c of the VNF (2) 504b. If conditions exist (e.g., a time of day window) such that the resources allocated to the VMs 506a, 506b, and 506c are insufficient to handle the processing load, or are otherwise determined that they will be insufficient to handle the processing load, the host agent 110 is configured to scale-out the VNF (1) 504a to include at least the VM (1) 506d of the VNF (2) 504b. Accordingly, subsequent to the scale-out being completed and at least the VM (1) 506d is active on the second socket, new network traffic sessions received by the steering point (2) 502b can be redirected to the steering point (3) 502c (e.g., via the interconnect 510) to be processed by at least the VM (1) 506b of the VNF (2) 504b.

It should be appreciated that the inter-socket scale out operation as described herein may require additional logic, e.g., the control plane logic may need to check the state of the target VM resources before commencement of the scale-out, and may also require a way to scale-in without disruption. For example, some sessions may still be active on the second socket before scale-in. Accordingly, in some embodiments, a threshold can be set for scale-in based on time of day, session count, or combination thereof. Depending on the embodiment, such an operation may be configurable by a service provider. In alternative embodiments, state could be maintained for the sessions such that the sessions can be moved off source VMs; however, advanced control plane logic would likely be required to handle the scale-in. It should be further appreciated that the functions described herein, in application, should limit the impact on scale in/out policy/operation and provide a more efficient traffic steering logic that interworks with the scale in/out process.

### Examples

Illustrative examples of the technologies disclosed herein are provided below. An embodiment of the technologies may include any one or more, and any combination of, the examples described below.

Example 1 includes a compute device for load-aware traffic steering, the compute device comprising a multi-homed network interface controller (NIC) that includes a plurality of NICs; network traffic analyzer circuitry to analyze a received network packet to determine a processing operation to be performed on the received network packet; and host agent circuitry to determine a target virtual network function (VNF) of a plurality of VNFs to perform the determined processing operation; identify a first steering point of a first NIC of the plurality of NICs to steer the received network packet to one or more virtual machines (VMs) associated with the determined target VNF; retrieve a resource utilization metric that corresponds to a usage level of a component of the compute device used by the one or more virtual machines (VMs) of the target VNF to perform the processing operation; determine whether the resource utilization metric indicates a potential overload condition; identify, in response to a determination that the resource utilization metric indicates a potential overload condition, a second steering point of a second NIC of the plurality of NICs to steer network traffic to one or more other VMs; and provide a steering instruction to the second steering point that is usable to redirect the network traffic to the one or more other VMs via the identified second steering point.

Example 2 includes the subject matter of Example 1, and wherein to provide the steering instruction to the second steering point that is usable to redirect the network traffic to the one or more other VMs comprises to update an access control list to map the received network packet to the second steering point.

Example 3 includes the subject matter of any of Examples 1 and 2, and wherein the resource utilization metric comprises a processing load.

Example 4 includes the subject matter of any of Examples 1-3, and wherein to determine whether the resource utilization metric indicates the potential overload condition comprises to determine whether the processing load exceeds a maximum processing load threshold.

Example 5 includes the subject matter of any of Examples 1-4, and wherein the resource utilization metric comprises a memory throttling percentage.

Example 6 includes the subject matter of any of Examples 1-5, and wherein to determine whether the resource utilization metric indicates the potential overload condition comprises to determine whether the memory throttling percentage exceeds a memory throttling threshold percentage.

Example 7 includes the subject matter of any of Examples 1-6, and further including a first processor and a second processor, wherein a first VNF of the plurality of VNFs is deployed on the first processor, and wherein a second VNF of the plurality of VNFs is deployed on the second processor.

Example 8 includes the subject matter of any of Examples 1-7, and wherein to redirect the network traffic to the one or more other VMs comprises to redirect the network traffic to one or more VMs of the first VNF whose resource utilization metric does not indicate a potential overload condition.

Example 9 includes the subject matter of any of Examples 1-8, and wherein to redirect the network traffic to the one or more other VMs comprises to redirect, in response to a determination that resources allocated to the one or more VMs of the first VNF are insufficient to handle a processing load to be steered to the one or more VMs of the first VNF, the network traffic to one or more VMs of the second VNF, wherein the first VNF has been scaled-out to the second processor.

Example 10 includes the subject matter of any of Examples 1-9, and wherein to redirect the network traffic to the one or more other VMs comprises to redirect the network traffic to the one or more other VMs of the target VNF.

Example 11 includes the subject matter of any of Examples 1-10, and wherein to redirect the network traffic to the one or more other VMs comprises to redirect the network traffic received from subscribers that have been authenticated subsequent to the determination that the resource utilization metric indicates the potential overload condition.

Example 12 includes one or more machine-readable storage media comprising a plurality of instructions stored thereon that, in response to being executed, cause a compute device to analyze a received network packet to determine a processing operation to be performed on the received network packet; determine a target virtual network function (VNF) of a plurality of VNFs of the compute device to perform the determined processing operation; identify a first steering point of a first network interface controller (NIC) of a plurality of NICs of a multi-homed NIC of the compute device to steer the received network packet to one or more virtual machines (VMs) associated with the determined target VNF; retrieve a resource utilization metric that corresponds to a usage level of a component of the compute device used by the one or more virtual machines (VMs) of the target VNF to perform the processing operation; determine whether the resource utilization metric indicates a potential overload condition; identify, in response to a determination that the resource utilization metric indicates a potential overload condition, a second steering point of a second NIC of the plurality of NICs to steer network traffic to one or more other VMs; and provide a steering instruction to the second steering point that is usable to redirect the network traffic to the one or more other VMs via the identified second steering point.

Example 13 includes the subject matter of Example 12, and wherein to provide the steering instruction to the second steering point that is usable to redirect the network traffic to the one or more other VMs comprises to update an access control list to map the received network packet to the second steering point.

Example 14 includes the subject matter of any of Examples 12 and 13, and wherein the resource utilization metric comprises a processing load.

Example 15 includes the subject matter of any of Examples 12-14, and wherein to determine whether the resource utilization metric indicates the potential overload condition comprises to determine whether the processing load exceeds a maximum processing load threshold.

Example 16 includes the subject matter of any of Examples 12-15, and wherein the resource utilization metric comprises a memory throttling percentage.

Example 17 includes the subject matter of any of Examples 12-16, and wherein to determine whether the resource utilization metric indicates the potential overload condition comprises to determine whether the memory throttling percentage exceeds a memory throttling threshold percentage.

Example 18 includes the subject matter of any of Examples 12-17, and wherein to redirect the network traffic to the one or more other VMs comprises to redirect the network traffic to one or more VMs of a first VNF of plurality of VNFs deployed on a first processor of the compute device whose resource utilization metric does not indicate a potential overload condition.

Example 19 includes the subject matter of any of Examples 12-18, and wherein to redirect the network traffic to the one or more other VMs comprises to redirect, in response to a determination that resources allocated to the one or more VMs of the first VNF are insufficient to handle a processing load to be steered to the one or more VMs of the first VNF, the network traffic to one or more VMs of the second VNF, wherein the first VNF has been scaled-out to a second processor of the compute device whose resource utilization metric does not indicate a potential overload condition.

Example 20 includes the subject matter of any of Examples 12-19, and wherein to redirect the network traffic to the one or more other VMs comprises to redirect the network traffic to the one or more other VMs of the target VNF.

Example 21 includes the subject matter of any of Examples 12-20, and wherein to redirect the network traffic to the one or more other VMs comprises to redirect the network traffic received from subscribers that have been authenticated subsequent to the determination that the resource utilization metric indicates the potential overload condition.

Example 22 includes a compute device for load-aware traffic steering, the compute device comprising circuitry for analyzing a received network packet to determine a processing operation to be performed on the received network packet; means for determining a target virtual network function (VNF) of a plurality of VNFs of the compute device to perform the determined processing operation; means for identifying a first steering point of a first network interface controller (NIC) of a plurality of NICs of a multi-homed NIC of the compute device to steer the received network packet to one or more virtual machines (VMs) associated with the determined target VNF; means for retrieving a resource utilization metric that corresponds to a usage level of a component of the compute device used by the one or more virtual machines (VMs) of the target VNF to perform the processing operation; means for determining whether the resource utilization metric indicates a potential overload condition; means for identifying, in response to a determination that the resource utilization metric indicates a potential overload condition, a second steering point of a second NIC of the plurality of NICs to steer network traffic to one or more other VMs; and means for providing a steering instruction to the second steering point that is usable to redirect the network traffic to the one or more other VMs via the identified second steering point.

Example 23 includes the subject matter of Example 22, and wherein the resource utilization metric comprises a processing load, and wherein the means for determining whether the resource utilization metric indicates the potential overload condition comprises means for determining whether the processing load exceeds a maximum processing load threshold.

Example 24 includes the subject matter of any of Examples 22 and 23, and wherein the resource utilization metric comprises a memory throttling percentage, and wherein the means for determining to whether the resource utilization metric indicates the potential overload condition comprises means for determining whether the memory throttling percentage exceeds a memory throttling threshold percentage.

Example 25 includes the subject matter of any of Examples 22-24, and wherein the means for determining whether the resource utilization metric indicates the potential overload condition comprises means for determining whether the memory throttling percentage exceeds a memory throttling threshold percentage.

1. A compute device for load-aware traffic steering, the compute device comprising:
a multi-homed network interface controller (NIC) that includes a plurality of NICs;
network traffic analyzer circuitry configured to analyze a received network packet to determine a processing operation to be performed on the received network packet; and
host agent circuitry configured to:
determine a target virtual network function (VNF) of a plurality of VNFs to perform the determined processing operation;
identify a first steering point of a first NIC of the plurality of NICs to steer the received network packet to one or more virtual machines (VMs) associated with the determined target VNF;
retrieve a resource utilization metric that corresponds to a usage level of a component of the compute device used by the one or more VMs of the target VNF to perform the processing operation;
determine whether the resource utilization metric indicates a potential overload condition;
identify, in response to a determination that the resource utilization metric indicates a potential overload condition, a second steering point of a second NIC of the plurality of NICs to steer network traffic to one or more other VMs; and
provide a steering instruction to the second steering point that is usable to redirect the network traffic to the one or more other VMs via the identified second steering point.

2. The compute device of claim 1, wherein to provide the steering instruction to the second steering point that is usable to redirect the network traffic to the one or more other VMs comprises to update an access control list to map the received network packet to the second steering point.

3. The compute device of claim 1, wherein the resource utilization metric comprises a processing load.

4. The compute device of claim 3, wherein to determine whether the resource utilization metric indicates the potential overload condition comprises to determine whether the processing load exceeds a maximum processing load threshold.

5. The compute device of claim 1, wherein the resource utilization metric comprises a memory throttling percentage.

6. The compute device of claim 5, wherein to determine whether the resource utilization metric indicates the potential overload condition comprises to determine whether the memory throttling percentage exceeds a memory throttling threshold percentage.

7. The compute device of claim 1, further comprising a first processor and a second processor, wherein a first VNF of the plurality of VNFs is deployed on the first processor, and wherein a second VNF of the plurality of VNFs is deployed on the second processor.

8. The compute device of claim 7, wherein to redirect the network traffic to the one or more other VMs comprises to redirect the network traffic to one or more VMs of the first VNF whose resource utilization metric does not indicate a potential overload condition.

9. The compute device of claim 7, wherein to redirect the network traffic to the one or more other VMs comprises to redirect, in response to a determination that resources allocated to the one or more VMs of the first VNF are insufficient to handle a processing load to be steered to the one or more VMs of the first VNF, the network traffic to one or more VMs of the second VNF, wherein the first VNF has been scaled-out to the second processor.

10. The compute device of claim 1, wherein to redirect the network traffic to the one or more other VMs comprises to redirect the network traffic to the one or more other VMs of the target VNF.

11. The compute device of claim 1, wherein to redirect the network traffic to the one or more other VMs comprises to redirect the network traffic received from subscribers that have been authenticated subsequent to the determination that the resource utilization metric indicates the potential overload condition.

12. One or more machine-readable storage media comprising a plurality of instructions stored thereon that, in response to being executed, cause a compute device to:
analyze a received network packet to determine a processing operation to be performed on the received network packet;
determine a target virtual network function (VNF) of a plurality of VNFs of the compute device to perform the determined processing operation;
identify a first steering point of a first network interface controller (NIC) of a plurality of NICs of a multi-homed NIC of the compute device to steer the received network packet to one or more virtual machines (VMs) associated with the determined target VNF;
retrieve a resource utilization metric that corresponds to a usage level of a component of the compute device used by the VMs of the target VNF to perform the processing operation;
determine whether the resource utilization metric indicates a potential overload condition;
identify, in response to a determination that the resource utilization metric indicates a potential overload condition, a second steering point of a second NIC of the plurality of NICs to steer network traffic to one or more other VMs; and
provide a steering instruction to the second steering point that is usable to redirect the network traffic to the one or more other VMs via the identified second steering point.

13. The one or more machine-readable storage media of claim 12, wherein to provide the steering instruction to the second steering point that is usable to redirect the network traffic to the one or more other VMs comprises to update an access control list to map the received network packet to the second steering point.

14. The one or more machine-readable storage media of claim 12, wherein the resource utilization metric comprises a processing load.

15. The one or more machine-readable storage media of claim 14, wherein to determine whether the resource utilization metric indicates the potential overload condition comprises to determine whether the processing load exceeds a maximum processing load threshold.

16. The one or more machine-readable storage media of claim 12, wherein the resource utilization metric comprises a memory throttling percentage.

17. The one or more machine-readable storage media of claim 15, wherein to determine whether the resource utilization metric indicates the potential overload condition comprises to determine whether the memory throttling percentage exceeds a memory throttling threshold percentage.

18. The one or more machine-readable storage media of claim 12, wherein to redirect the network traffic to the one or more other VMs comprises to redirect the network traffic to one or more VMs of a first VNF of plurality of VNFs deployed on a first processor of the compute device whose resource utilization metric does not indicate a potential overload condition.

19. The one or more machine-readable storage media of claim 18, wherein to redirect the network traffic to the one or more other VMs comprises to redirect, in response to a determination that resources allocated to the one or more VMs of the first VNF are insufficient to handle a processing load to be steered to the one or more VMs of the first VNF, the network traffic to one or more VMs of the second VNF, wherein the first VNF has been scaled-out to a second processor of the compute device whose resource utilization metric does not indicate a potential overload condition.

20. The one or more machine-readable storage media of claim 12, wherein to redirect the network traffic to the one or more other VMs comprises to redirect the network traffic to the one or more other VMs of the target VNF.

21. The one or more machine-readable storage media of claim 12, wherein to redirect the network traffic to the one or more other VMs comprises to redirect the network traffic received from subscribers that have been authenticated subsequent to the determination that the resource utilization metric indicates the potential overload condition.

22. A compute device for load-aware traffic steering, the compute device comprising:
circuitry for analyzing a received network packet to determine a processing operation to be performed on the received network packet;
means for determining a target virtual network function (VNF) of a plurality of VNFs of the compute device to perform the determined processing operation;
means for identifying a first steering point of a first network interface controller (NIC) of a plurality of NICs of a multi-homed NIC of the compute device to steer the received network packet to one or more virtual machines (VMs) associated with the determined target VNF;
means for retrieving a resource utilization metric that corresponds to a usage level of a component of the compute device used by the one or more VMs of the target VNF to perform the processing operation;
means for determining whether the resource utilization metric indicates a potential overload condition;
means for identifying, in response to a determination that the resource utilization metric indicates a potential overload condition, a second steering point of a second NIC of the plurality of NICs to steer network traffic to one or more other VMs; and
means for providing a steering instruction to the second steering point that is usable to redirect the network traffic to the one or more other VMs via the identified second steering point.

23. The compute device of claim 22, wherein the resource utilization metric comprises a processing load, and wherein the means for determining whether the resource utilization metric indicates the potential overload condition comprises means for determining whether the processing load exceeds a maximum processing load threshold.

24. The compute device of claim 22, wherein the resource utilization metric comprises a memory throttling percentage, and wherein the means for determining to whether the resource utilization metric indicates the potential overload condition comprises means for determining whether the memory throttling percentage exceeds a memory throttling threshold percentage.

25. The compute device of claim 22, wherein the means for determining whether the resource utilization metric indicates the potential overload condition comprises means for determining whether the memory throttling percentage exceeds a memory throttling threshold percentage.
